(19) United States
(12) Patent Application Publication
(10) Pub. No.: US 2018/0056591 A1
(43) Pub. Date: Mar. 1, 2018

(54) METHOD FOR PRODUCING THREE-DIMENSIONAL OBJECT AND METHOD FOR CONTROLLING THREE-DIMENSIONAL OBJECT PRODUCTION SYSTEM

(71) Applicant: MIMAKI ENGINEERING CO., LTD., Nagano (JP)

(72) Inventors: Kenji HARAYAMA, Nagano (JP); Masakatsu OKAWA, Nagano (JP); Kazuhiro OCHI, Nagano (JP); Hiroyoshi OHI, Nagano (JP)

(21) Appl. No.: 15/683,244

(22) Filed: Aug. 22, 2017

(30) Foreign Application Priority Data
Aug. 29, 2016 (JP) 2016-166965

(51) Int. Cl. B29C 64/393; B29C 64/112; B33Y 10/00; B33Y 50/02; B29C 65/48; B33Y 40/00

(52) U.S. Cl. CPC B29C 64/393; B29C 64/112; B33Y 40/00; B33Y 50/02; B29C 65/48; B33Y 10/00

(57) ABSTRACT

A method includes an object segment forming step of forming a plurality of object segments and a joining step of joining the plurality of object segments to each other via joint surfaces. The object segment forming step includes forming a first object segment having an upper surface serving as a first joint surface and a second object segment having an upper surface serving as a second joint surface or forming the first object segment having a lower surface serving as the first joint surface and the second object segment having a lower surface serving as the second joint surface.

### CROSS-REFERENCE TO RELATED APPLICATIONS

The present application claims priority under 35 U.S.C. § 119 to Japanese Patent Application No. 2016-166965, filed August 29, 2016. The contents of this application are incorporated herein by reference in their entirety.

### BACKGROUND

### Field of the Invention

The present disclosure relates to a method for producing a three-dimensional object and a method for controlling a three-dimensional object production system.

### Discussion of the Background

JP2009-83491A1 discloses a method for producing a three-dimensional object. The method for producing a three-dimensional object disclosed in JP2009-83491A1 includes producing a plurality of object segments of a three-dimensional object, and then joining the plurality of object segments thus produced with each other to produce a large three-dimensional object.

The contents of JP2009-83491A1 are incorporated herein by reference in their entirety.

The method for producing a three-dimensional object disclosed in JP2009-83491A1, including joining a plurality of object segments to each other, might result in a three-dimensional object with an appearance compromised by noticeable joint portions among segments. Thus, the three-dimensional object is preferably produced with less-noticeable joint portions among the plurality of object segments joined to each other.

In light of the above circumstances, it is an object of the present disclosure to provide a method for producing a three-dimensional object and a method for controlling a three-dimensional object production system that ensure a three-dimensional object, including a plurality of object segments joined to each other at joint surfaces, to be produced with less noticeable joint portions among the object segments.

### SUMMARY

According to one aspect of the present disclosure, a method for producing a three-dimensional object including a plurality of object segments joined to each other via joint surfaces according to the present disclosure includes: an object segment forming step of depositing layers of ink, formed of ink extruded from an ink-jet head, on a table to form the plurality of object segments; and a joining step of joining the plurality of object segments, formed in the object segment forming step, to each other via the joint surfaces. The object segment forming step includes forming a first object segment having an upper surface serving as a first joint surface and a second object segment having an upper surface serving as a second joint surface or forming the first object segment having a lower surface serving as the first joint surface and the second object segment having a lower surface serving as the second joint surface, the first object segment and the second object segment respectively being one and another one of the plurality of object segments joined to each other via the joint surfaces in the joining step, the first joint surface of the first object segment and the second joint surface of the second object segment each being a corresponding one of the joint surfaces.

The method for producing a three-dimensional object according to the present includes forming the first object segment having the upper surface serving as the first joint surface and the second object segment having the upper surface serving as the second joint surface or forming the first object segment having the lower surface serving as the first joint surface and the second object segment having the lower surface serving as the second joint surface. Thus, in the present disclosure, the first joint surface and the second joint surface are formed at approximately the same timing in the object segment forming step.

Thus, the present disclosure ensures that a difference in a color or a dimensional accuracy between the first joint surface and the second joint surface is less likely to occur due to a change in the status of the ink-jet head over a period of time. In other words, the present disclosure ensures that the properties such as the color or the dimensional accuracy match between the first joint surface and the second joint surface. Thus, the present disclosure ensures a less noticeable joint portion, between the first object segment and the second object segment, formed by joining the first joint surface and the second joint surface to each other. All things considered, the present disclosure ensures that a three-dimensional object including a plurality of object segments joined to each other via joint surfaces is produced with a less-noticeable joint portion between the object segments.

In the present disclosure, one of the layers of ink including the first joint surface and one of the layers of ink including the second joint surface are preferably formed through a single scanning operation. This configuration facilitates an attempt to form the first joint surface and the second joint surface at the same timing, and thus ensures that the properties more match between the first joint surface and the second joint surface. Thus, the configuration ensures an even less noticeable joint portion between the object segments.

For example, in the present disclosure, one of the layers of ink including the first joint surface and one of the layers of ink including the second joint surface are each a layer of color ink. The layers of color ink as the layer of ink including the first joint surface and the layer of ink including the second joint surface lead to a noticeable joint portion between the first object segment and the second object segment, due to a difference in a color between the first joint surface and the second joint surface. Still, the present disclosure ensures that the color tone matches between the first joint surface and the second joint surface, and thus ensures a less noticeable joint portion between the first object segment and the second object segment even when the layer of ink including the first joint surface and the layer of ink including the second joint surface are layers of color ink.

A method for controlling a three-dimensional object production system configured to produce a three-dimensional object including a plurality of object segments joined to each other via joint surfaces for achieving the object described above includes: a data dividing step of diving three-dimensional data corresponding to the three-dimensional object at virtual joint surfaces corresponding to the joint surfaces to generate a plurality of three-dimensional data segments corresponding to the plurality of object segments; and an object segment forming step of depositing layers of ink, formed of ink extruded from an ink-jet head, on a table to form the plurality of object segments. The object segment forming step includes forming a first object segment, as one of the object segments corresponding to a first three-dimensional data segment, having an upper surface serving as a first joint surface that is one of the joint surfaces corresponding to a first virtual joint surface and a second object segment, as one of the object segments corresponding to a second three-dimensional data segment, having an upper surface serving as a second joint surface that is one of the joint surfaces corresponding to a second virtual joint surface, or forming the first object segment having a lower surface serving as the first joint surface and the second object segment having a lower surface serving as the second joint surface, the first three-dimensional data segment and the second three-dimensional data segment respectively being one and another one of the three-dimensional data segments divided at the virtual joint surfaces in the data dividing step, the first virtual joint surface of the first three-dimensional data segment being one of the virtual joint surfaces joined to the second three-dimensional data segment, the second virtual joint surface of the second three-dimensional data segment being one of the virtual joint surfaces joined to the first three-dimensional data segment.

The method for controlling a three-dimensional object production system according to the present disclosure includes the object segment forming step including forming a first object segment, as one of the object segments corresponding to a first three-dimensional data segment, having an upper surface serving as a first joint surface that is one of the joint surfaces corresponding to a first virtual joint surface and a second object segment, as one of the object segments corresponding to a second three-dimensional data segment, having an upper surface serving as a second joint surface that is one of the joint surfaces corresponding to a second virtual joint surface, or forming the first object segment having a lower surface serving as the first joint surface and the second object segment having a lower surface serving as the second joint surface, the first three-dimensional data segment and the second three-dimensional data segment respectively being one and another one of the three-dimensional data segments divided at the virtual joint surfaces in the data dividing step, the first virtual joint surface of the first three-dimensional data segment being one of the virtual joint surfaces joined to the second three-dimensional data segment, the second virtual joint surface of the second three-dimensional data segment being one of the virtual joint surfaces joined to the first three-dimensional data segment. Thus, in the present disclosure, the first joint surface and the second joint surface are formed at approximately the same timing in the object segment forming step.

Thus, the present disclosure ensures that a difference in a color or a dimensional accuracy between the first joint surface and the second joint surface is less likely to occur due to a change in the status of the ink-jet head over a period of time. In other words, the present disclosure ensures that the properties such as the color or the dimensional accuracy match between the first joint surface and the second joint surface. Thus, the present disclosure ensures a less noticeable joint portion, between the first object segment and the second object segment, formed by joining the first joint surface and the second joint surface to each other. All things considered, the present disclosure ensures that a three-dimensional object including a plurality of object segments joined to each other via joint surfaces is produced with a less-noticeable joint portion between the object segments.

The above-described embodiments of the present disclosure ensure that a three-dimensional object including a plurality of object segments joined to each other via joint surfaces is produced with a less-noticeable joint portion between the object segments.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A and FIG. 1B are diagrams illustrating a configuration of a three-dimensional object manufactured by a method for producing a three-dimensional object according to an embodiment of the present disclosure;

FIG. 2A, FIG. 2B, and FIG. 2C are diagrams illustrating the method for producing the three-dimensional object illustrated in FIG. 1;

FIG. 3 is a block diagram illustrating a three-dimensional object production system for producing the three-dimensional object illustrated in FIG. 1;

FIG. 4A and FIG. 4B are diagrams illustrating a three-dimensional data segment generated by an upper level device illustrated in FIG. 3;

FIG. 5 is a flowchart illustrating an example of a method for controlling the three-dimensional object production system illustrated in FIG. 3;

FIG. 6A, FIG. 6B, FIG. 6C, and FIG. 6D are diagrams illustrating a method for forming segments according to another embodiment of the present disclosure;

FIG. 7A and FIG. 7B are diagrams illustrating a method for forming segments according to still another embodiment of the present disclosure;

FIG. 8 is a flowchart illustrating a method for controlling a three-dimensional object production system according to another embodiment of the present disclosure; and

FIG. 9 is a diagram illustrating an example of an assembly diagram printed by a printer illustrated in FIG. 3.

### DESCRIPTION OF THE EMBODIMENTS

The embodiments will now be described with reference to the accompanying drawings, wherein like reference numerals designate corresponding or identical elements throughout the various drawings.

### (Method for Producing a Three-Dimensional Object)

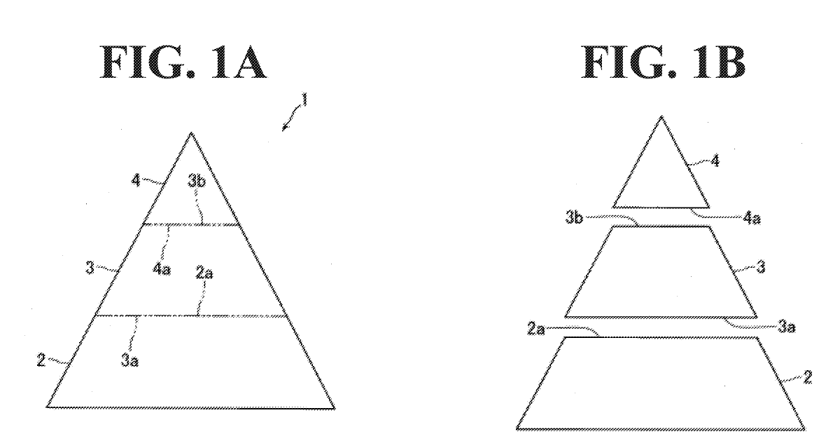

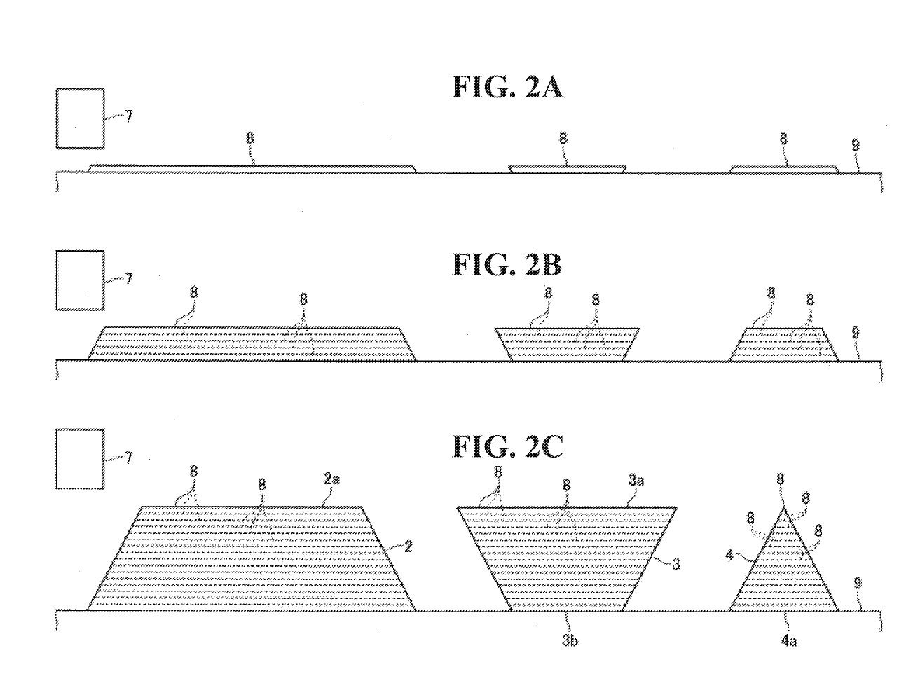

FIG. 1A and FIG. 1B are diagrams illustrating a configuration of a three-dimensional object 1 produced by a method for producing a three-dimensional object according to an embodiment of the present disclosure. FIG. 2A, FIG. 2B, and FIG. 2C are diagrams illustrating a method for producing the three-dimensional object 1 illustrated in FIG. 1.

For example, the three-dimensional object 1 produced by the method for producing a three-dimensional object according to the present embodiment is a cone-shaped object. The three-dimensional object 1 includes a plurality of object segments 2 to 4. More specifically, the three segments 2 to 4 of the three-dimensional object 1 according to the present embodiment include the object segment 2 having a frustum shape, the object segment 3 having a frustum shape, and the object segment 4 having a frustum shape.

The three-dimensional object 1 is formed with a top surface (a surface with a smaller diameter) of the object segment 2 and a bottom surface (a surface with a larger diameter) of the object segment 3 joined to each other with an adhesive, and a top surface (a surface with a smaller diameter) of the object segment 3 and a bottom surface of the object segment 4 joined to each other with an adhesive. Thus, the object segment 2 has the top surface as a joint surface 2a joined to the object segment 3, the object segment 3 has the bottom surface as a joint surface 3a joined to the object segment 2, the object segment 3 has the top surface as a joint surface 3b joined to the object segment 4, and the object segment 4 has the bottom surface as a joint surface 4a joined to the object segment 3. The joint surface 2a and the joint surface 3a have the same outer diameter. The joint surface 3b and the joint surface 4a have the same outer diameter.

The three-dimensional object 1 is manufactured as follows. First of all, layers of ink 8, formed with ink extruded from an ink-jet head 7, are deposited on a table 9 to form the three segments 2 to 4 (segment forming process). FIGS. 2A to 2C illustrate how the layers of ink 8 are successively deposited to form the three segments 2 to 4. For example, the ink-jet head 7 extrudes an ultraviolet curable ink. The ink-jet head 7 is mounted on a carriage (not illustrated), and moves in a main scanning direction. For example, the table 9 is coupled to a lifting and lowering mechanism (not illustrated) that lifts and lowers the table 9. The table 9 is lowered by a distance corresponding to a thickness of a single layer of ink 8, each time one layer(s) of ink 8 is formed. The table 9 is also coupled to a moving mechanism (not illustrated) that moves the table 9 in a sub-scanning direction. Thus, the table 9 moves in the sub-scanning direction as necessary.

The object segment forming process includes forming the object segment 2 having the upper surface serving as the joint surface 2a, forming the object segment 3 having the upper surface serving as the joint surface 3a and the lower surface serving as the joint surface 3b, and forming the object segment 4 having the lower surface serving as the joint surface 4a. More specifically, the object segments 2 and 3 are formed with the joint surface 2a being the upper surface of the object segment 2, and the joint surface 3a being the upper surface of the object segment 3. The object segments 3 and 4 are formed with the joint surface 3b being the lower surface of the object segment 3, and the joint surface 4a being the lower surface of the object segment 4.

The object segment forming process includes forming layers of ink 8 including the joint surface 2a and the joint surface 3a, as well as layers of ink 8 including the joint surface 3b and the joint surface 4a through a single scanning operation. The layers of ink 8 including the joint surface 2a and the joint surface 3a have the same color. The layers of ink 8 including the joint surface 3b and the joint surface 4a have the same color. The object segment 3 formed in the object segment forming process is supported by a support member not illustrated in FIG. 2.

The object segments 2 to 4 formed in the object segment forming process are joined to each other (joining process). More specifically, the object segment 2 and the object segment 3 are joined to each other via the joint surfaces 2a and 3a, and the object segment 3 and the object segment 4 are joined to each other via the joint surfaces 3b and 4a. With the object segment 2 and the object segment 3 joined to each other and the object segment 3 and the object segment 4 joined to each other in the joining process, the three-dimensional object 1 is completed.

The object segment 2 and the object segment 3 according to the present embodiment are respectively a first object segment and a second object segment, recited in the appended claims, as one and the other one of segments joined to each other via a first joint surface and a second joint surface, also recited in the appended claims, respectively corresponding to the joint surfaces 2a and 3a, in the joining process. The object segment 3 and the object segment 4 are respectively the first object segment and the second object segment, recited in the appended claims, as one and the other one of the object segments joined to each other via the first joint surface and the second joint surface, also recited in the appended claims, respectively corresponding to the joint surfaces 3b and 4a, in the joining process.

### (Configuration of Three-Dimensional Object Production System and Method for Controlling the System)

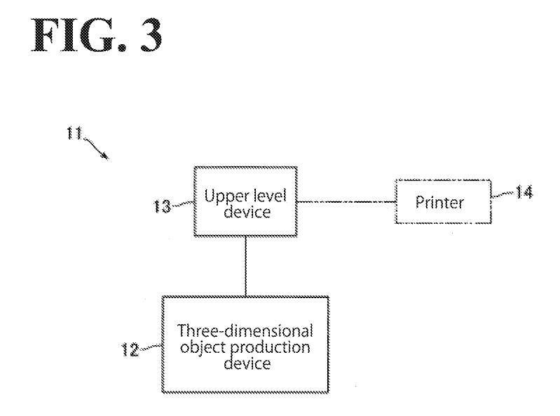

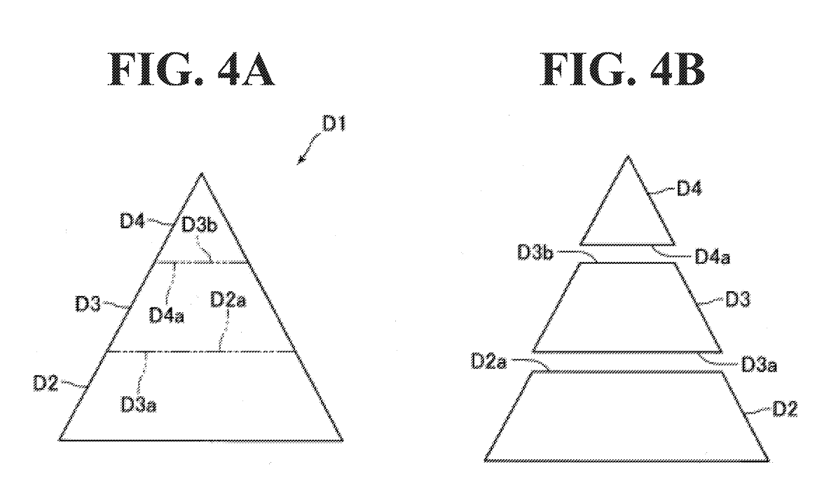

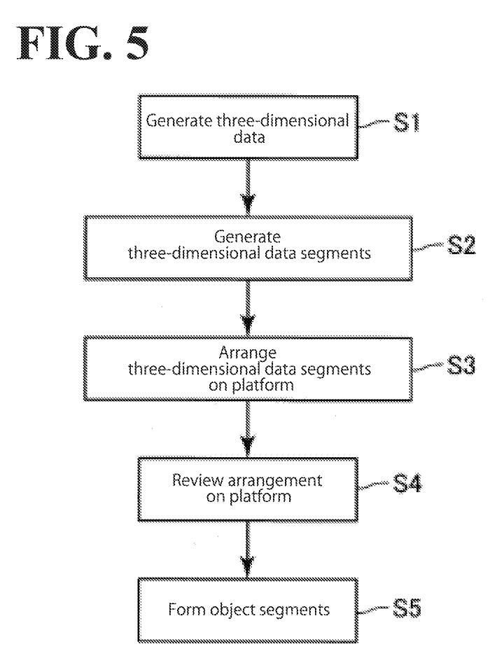

FIG. 3 is a block diagram of a three-dimensional object production system 11 for producing the three-dimensional object 1 illustrated in FIG. 1. FIG. 4A and FIG. 4B are diagrams illustrating three-dimensional data segments D2 to D4 generated in an upper level device 13 illustrated in FIG. 3. FIG. 5 is a flowchart illustrating an example of a method for controlling the three-dimensional object production system 11 illustrated in FIG. 3

The object segments 2 to 4 are formed in the three-dimensional object production system 11. The three-dimensional object production system 11 includes a three-dimensional object production device 12 and the upper level device 13. The three-dimensional object production device 12 includes the ink-jet head 7, the table 9, the carriage (not illustrated), the lifting and lowering mechanism (not illustrated) for the table 9, and the moving mechanism (not illustrated) for the table 9. A non-limiting example of the upper level device 13 includes a personal computer (PC) including a display device (not illustrated).

FIG. 5 illustrates how the three-dimensional object production system 11 forms the object segments 2 to 4. First of all, the upper level device 13 generates three-dimensional data D1 (data on the shape of the three-dimensional object 1, see FIG. 4A) corresponding to the three-dimensional object 1 (step S1). Then, the upper level device 13 divides the three-dimensional data D1 at virtual joint surfaces D2a, D3a, D3b, and D4a, respectively corresponding to the joint surfaces 2a, 3a, 3b, and 4a, to generate the three three-dimensional data segments D2 to D4 (data on the shapes of the object segments 2 to 4, see FIG. 4A and FIG. 4B) respectively corresponding to the three segments 2 to 4 (step S2, data dividing step).

More specifically, in step S2, the upper level device 13 divides the three-dimensional data D1 at the virtual joint surface D2a and the virtual joint surface D3a respectively corresponding to the joint surface 2a and the joint surface 3a, and at the virtual joint surface D3b and the virtual joint surface D4a respectively corresponding to the joint surface 3b and the joint surface 4a. Thus, the three-dimensional data segments D2 to D4 respectively corresponding to the object segments 2 to 4 are generated.

Then, the upper level device 13 arranges the three-dimensional data segments D2 to D4, generated in step S2, on the upper surface (platform) of the table 9 displayed on the display device of the upper level device 13 (step S3). The arrangement of the three-dimensional data segments D2 to D4 on the platform is reviewed as necessary (step S4). Then, the three-dimensional object production device 12 deposits the layers of ink 8 on the table 9 based on the shapes and the arrangement of the three-dimensional data segments D2 to D4 transmitted from the upper level device 13 to form the object segments 2 to 4 (step S5, segment forming step).

Step S5 corresponds to the object segment forming process described above. Thus, in step S5, the object segment 2 is formed to have the upper surface serving as the joint surface 2a, the object segment 3 is formed to have the upper surface serving as the joint surface 3b and the lower surface serving as the joint surface 3a, and the object segment 4 is formed to have the lower surface serving as the joint surface 4a.

The three-dimensional data segment D2 and the three-dimensional data segment D3 according to the present embodiment are respectively a first three-dimensional data segment and a second three-dimensional data segment, as recited in the appended claims. The first three-dimensional data segment and the second three-dimensional data segment are one three-dimensional data segment and the other three-dimensional data segment, as a result of the dividing at the virtual joint surfaces D2a and D3a, respectively corresponding to a first virtual joint surface and a second virtual joint surface as recited in the appended claims, in data dividing step S2. The joint surface 2a and the joint surface 3a are respectively the first joint surface and the second joint surface, respectively corresponding to the virtual joint surface D2a and the virtual joint surface D3a.

The three-dimensional data segment D3 and the three-dimensional data segment D4 are respectively the first three-dimensional data segment and the second three-dimensional data segment, as recited in the appended claims. The first three-dimensional data segment and the second three-dimensional data segment are one three-dimensional data segment and the other three-dimensional data segment, as a result of the dividing at the virtual joint surfaces D3b and D4a, respectively corresponding to the first virtual joint surface and the second virtual joint surface as recited in the appended claims, in data dividing step S2. The joint surface 3b and the joint surface 4a are respectively the first joint surface and the second joint surface, respectively corresponding to the virtual joint surface D3b and the virtual joint surface D4a.

### (Main Effect of the Present Embodiment)

In the object segment forming process according to the present embodiment described above, the object segment 2 is formed to have the upper surface serving as the joint surface 2a, the object segment 3 is formed to have the upper surface serving as the joint surface 3b and the lower surface serving as the joint surface 3a, and the object segment 4 is formed to have the lower surface serving as the joint surface 4a. Thus, in this embodiment, the joint surface 2a and the joint surface 3a joined to each other are formed at approximately the same timing, and the joint surface 3b and the joint surface 4a joined to each other are formed at approximately the same timing.

Thus, this embodiment ensures that a difference in a color between the joint surface 2a and the joint surface 3a and between the joint surface 3b and the joint surface 4a. or a difference in dimensional accuracy between the joint surface 2a and the joint surface 3a or between the joint surface 3b and the joint surface 4a, due to a change in the status of the ink-jet head 7 over a period of time. Thus, this embodiment ensures that properties such as color and dimensional accuracy match between the joint surface 2a and the joint surface 3a, and between the joint surface 3b and the joint surface 4a.

Thus, this embodiment ensures a less noticeable joint portion between the object segments 2 and 3 joined to each other via the joint surface 2a and the joint surface 3a, and a less noticeable joint portion between the object segments 3 and 4 joined to each other via the joint surface 3b and the joint surface 4a. All things considered, this embodiment ensures that the three-dimensional object 1, including the three segments 2 to 4 joined to each other at the joints surfaces 2a, 3a, 3b, and 4a, is produced with less-noticeable joint portions.

### (Modification of Method for Forming Segment)

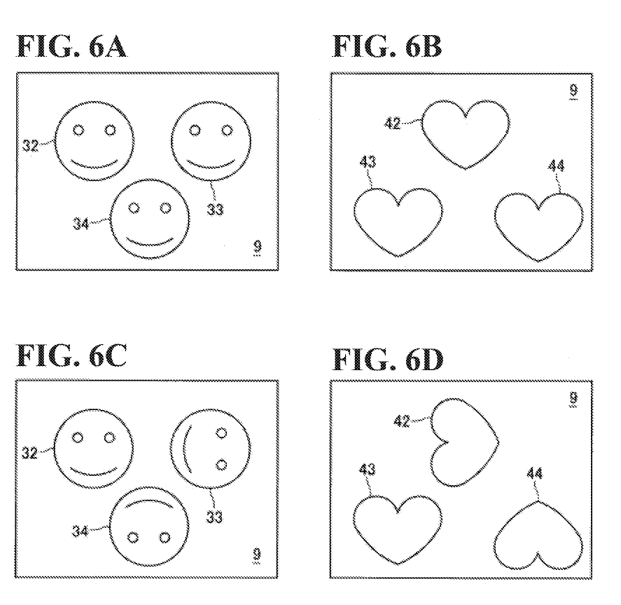

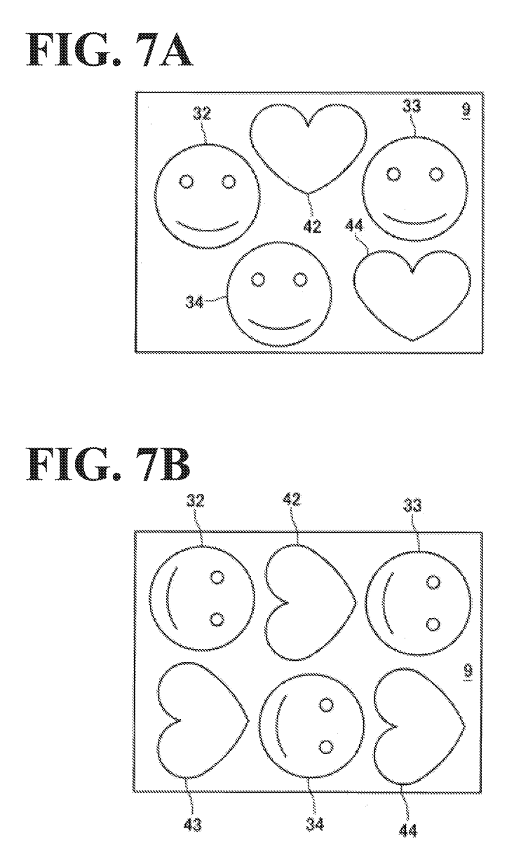

FIG. 6A, FIG. 6B, FIG. 6C, FIG. 6D, FIG. 7A and FIG. 7B are diagrams illustrating methods for forming segments 32 to 34 and segments 42 to 44 according to other embodiments of the present disclosure.

The three-dimensional object 1 according to the embodiment described above is a cone-shaped object with no features defining orientations in a rotational direction about an axis of the three-dimensional object 1. Alternatively, the three-dimensional object 1 may have an orientation in the rotational direction about the axis of the three-dimensional object 1. Non-limiting examples of such a three-dimensional object 1 include a cylindrical object having a graphic formed completely over an axial direction as illustrated in FIG. 6A, and a columnar object having a cross-sectional shape of a heart as illustrated in FIG. 6B.

For example, the three-dimensional object 1 as the cylindrical object having a graphic formed completely over the axial direction as illustrated in FIG. 6A includes the three cylindrical segments 32 to 34. An object segment forming process for this configuration includes forming the object segments 32 to 34 with the orientation of the object segment 32 relative to the object segments 33 and 34 matching the orientation of the object segment 32 relative to the object segments 33 and 34 after the object segments 32 to 34 are joined to each other. More specifically, the object segment forming process is performed to form the object segments 32 to 34 to have the same orientation of the graphics as illustrated in FIG. 6A.

In step S3 according to this embodiment, the upper level device 13 automatically arranges three three-dimensional data segments, respectively corresponding to the object segments 32 to 34, on the platform with a uniform orientation of the graphics of the three three-dimensional data segments. In step S3, the upper level device 13 may arrange the three three-dimensional data segments on the platform all at once or one by one in any appropriate order.

For example, the three-dimensional object 1 as the columnar object having the cross-sectional shape of a heart as illustrated in FIG. 6B includes the three segments 42 to 44. an object segment forming process for this configuration includes forming the object segments 42 to 44 with the orientation of the object segment 42 relative to the object segments 43 and 44 matching the orientation of the object segment 42 relative to the object segments 43 and 44 after the object segments 42 to 44 are joined to each other. More specifically, the object segment forming is performed to form the object segments 42 to 44 to have the same orientation as illustrated in FIG. 6B. In step S3 according to this embodiment, the upper level device 13 automatically arranges the three three-dimensional data segments, respectively corresponding to the object segments 42 to 44, on the platform with a uniform orientation.

The object segments 32 to 34 formed with the uniform orientation of the graphics in the object segment forming process ensure less noticeable joint portions among the object segments 32 to 34 after being joined to each other in the joining process, compared with the object segments 32 to 34 formed with different orientations of the graphics by the object segment forming process as illustrated in FIG. 6C. The object segments 42 to 44 formed with the uniform orientation in the object segment forming process ensure less-noticeable joint portions among the object segments 42 to 44 after being joined to each other in the joining process are less noticeable, compared with the object segments 42 to 44 formed with different orientations in the object segment forming process as illustrated in FIG. 6D.

The object segment forming process may be performed to simultaneously form the object segments 32 to 34 and the object segments 42 to 44. In step S3 in this segment forming step, the upper level device 13 arranges the three three-dimensional data segments, respectively corresponding to the object segments 32 to 34, as well as the three three-dimensional data segments, respectively corresponding to the object segments 42 to 44, on the platform. This might result in a failure to arrange the three-dimensional data segment, corresponding to the object segment 43, on the platform depending on the orientations of the three-dimensional data segments corresponding to the object segments 42 to 44 (see FIG. 7A).

Thus, in step S4, the upper level device 13 rearranges the three-dimensional data segments to ensure that the three-dimensional data segment corresponding to the object segment 43 is arranged on the platform. In this process, for example, the upper level device 13 rotates the three three-dimensional data segments in the same direction and by the same angle to ensure that the uniform orientation of the three three-dimensional data segments respectively corresponding to the object segments 42 to 44 is maintained (see FIG. 7B). The upper level device 13 rotates the three three-dimensional data segments in the same direction and by the same angle while maintaining the uniform orientation of the graphics of the three three-dimensional data segments respectively corresponding to the object segments 32 to 34 (see FIG. 7B).

### (Modification of Method for Controlling Three-Dimensional Object Production System)

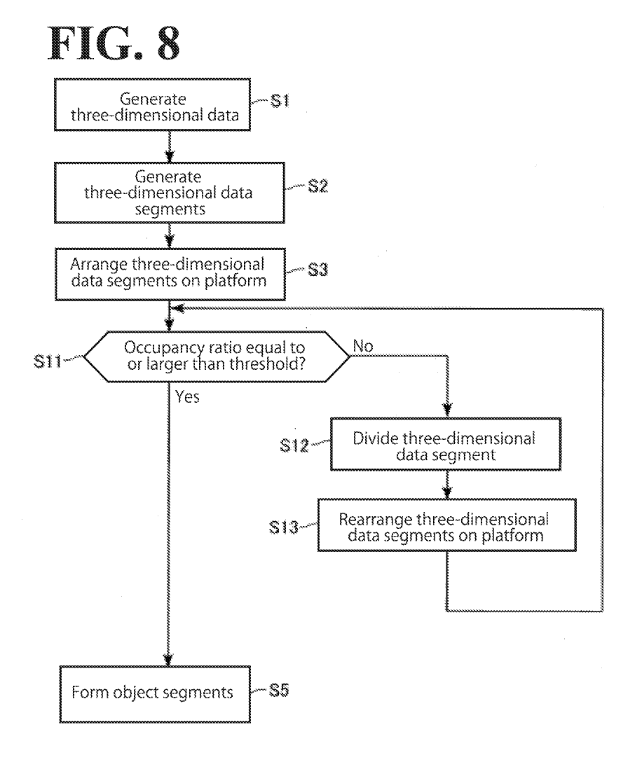

FIG. 8 is a flowchart illustrating a method for controlling the three-dimensional object production system 11 according to another embodiment of the present disclosure.

The three-dimensional object 1, which is the cone-shaped object in the embodiment described above, may also be an object with a complex shape such as a human-shaped object. The upper level device 13 forms such an object by first generating a three-dimensional data corresponding to the three-dimensional object 1 (step S1), and then dividing the data at any appropriate positions set by the user to generate a plurality of three-dimensional data segments (step S2). For example, in step S2, the upper level device 13 divides the three-dimensional data based on features such as a separation between colors of the three-dimensional object 1 and a difference in stages of the three-dimensional object 1. Then, the upper level device 13 arranges the three-dimensional data segments, generated in step S2, on the upper surface (platform) of the table 9 displayed on the display device of the upper level device 13 (step S3).

Then, the upper level device 13 calculates an occupancy ratio of the three-dimensional data segments, arranged on the platform, relative to the platform, and determines whether the occupancy ratio is equal to or larger than a predetermined threshold (step S11). When the occupancy ratio is determined to be equal to or larger than the threshold in step S11, the processing proceeds to step S5 to form the plurality of object segments of the three-dimensional object 1. When the occupancy ratio is determined to be smaller than the threshold in step S11, the upper level device 13 divides a three-dimensional data segment corresponding to a single segment (step S12). For example, in step S12, the upper level device 13 divides a three-dimensional data segment corresponding to the largest one of the plurality of object segments. Then, the upper level device 13 rearranges the three-dimensional data segments on the platform (step S13), and the processing returns to step S11.

The method for controlling the three-dimensional object production system 11 according to this modification ensures that the plurality of object segments are formed on the table 9 more efficiently, and thus with a shorter period of time. The three-dimensional data segment divided in step S12 might result in an object segment with a size smaller than a predetermined smallest tolerable size. In such a case, the three-dimensional data segments obtained by the dividing in step S12 may be recombined, and then the processing may proceed to step S5.

### (Other Embodiments)

In the embodiment described above, the object segment forming process may include forming the object segments 2 to 4 with the joint surface 2a being the upper surface of the object segment 2, the joint surface 3a being the upper surface of the object segment 3, the joint surface 3b being the lower surface of the object segment 3, and the joint surface 4a being the lower surface of the object segment 4. Alternatively, the object segment forming process may include forming the object segments 2 to 4 with the joint surface 2a being the lower surface of the object segment 2, the joint surface 3a being the lower surface of the object segment 3, the joint surface 3b being the upper surface of the object segment 3, and the joint surface 4a being the upper surface of the object segment 4.

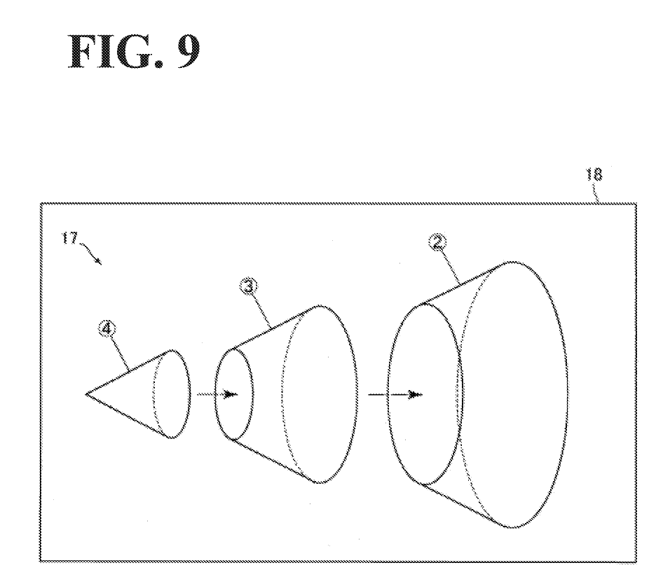

In step S2 according to the embodiment described above, the upper level device 13 may generate the three-dimensional data segments D2 to D4, obtained by dividing the three-dimensional data D1, together with an assembly diagram 17 (see FIG. 9) of the three-dimensional object 1. In this example, the assembly diagram 17 is printed on a printing sheet 18 by a printer 14 (see FIG. 3) connected to the upper level device 13. In the diagram, the object segments 2 to 4 may be provided with markings such as numbers to be distinguishable from one another. For example, the object segment 2, the object segment 3, and the object segment 4 may be respectively provided with a number “2”, a number “3”, and a number “4”.

1 . . . three-dimensional object, 2 . . . segment (first object segment), 2a . . . joint surface (first joint surface), 3 . . . segment (second object segment, the first object segment), 3a . . . joint surface (second joint surface), 3b . . . joint surface (first joint surface), 4 . . . segment (second object segment), 4a . . . joint surface (second joint surface), 7 . . . ink-jet head, 8 . . . layers of ink, 9 . . . table, D1 . . . three-dimensional data, D2 . . . three-dimensional data segment (first three-dimensional data segment), D2a . . . virtual joint surface (first virtual joint surface), D3 . . . three-dimensional data segment (second three-dimensional data segment, the first three-dimensional data segment), D3a . . . virtual joint surface (second virtual joint surface), D3b virtual joint surface (first virtual joint surface), D4 . . . three-dimensional data segment (second three-dimensional data segment), D4a . . . virtual joint surface (second virtual joint surface), S2 . . . data dividing step, S5 . . . segment forming step

What is claimed is:

1. A method for producing a three-dimensional object including a plurality of object segments joined to each other via joint surfaces, the method comprising:
an object segment forming step of depositing layers of ink, formed of ink extruded from an ink-jet head, on a table to form the plurality of object segments; and
a joining step of joining the plurality of object segments, formed in the object segment forming step, to each other via the joint surfaces,
wherein the object segment forming step comprises forming a first object segment having an upper surface serving as a first joint surface and a second object segment having an upper surface serving as a second joint surface or forming the first object segment having a lower surface serving as the first joint surface and the second object segment having a lower surface serving as the second joint surface, the first object segment and the second object segment respectively being one and another one of the plurality of object segments joined to each other via the joint surfaces in the joining step, the first joint surface of the first object segment and the second joint surface of the second object segment each being a corresponding one of the joint surfaces.

2. The method for producing a three-dimensional object according to claim 1, wherein the object segment forming step comprises forming one of the layers of ink including the first joint surface and one of the layers of ink including the second joint surface through a single scanning operation.

3. The method for producing a three-dimensional object according to claim 1, wherein one of the layers of ink including the first joint surface and one of the layers of ink including the second joint surface are each a layer of color ink.

4. A method for controlling a three-dimensional object production system configured to produce a three-dimensional object including a plurality of object segments joined to each other via joint surfaces, the method comprising:
a data dividing step of diving three-dimensional data corresponding to the three-dimensional object at virtual joint surfaces corresponding to the joint surfaces to generate a plurality of three-dimensional data segments corresponding to the plurality of object segments; and
an object segment forming step of depositing layers of ink, formed of ink extruded from an ink-jet head, on a table to form the plurality of object segments,
wherein the object segment forming step comprises forming a first object segment, as one of the object segments corresponding to a first three-dimensional data segment, having an upper surface serving as a first joint surface that is one of the joint surfaces corresponding to a first virtual joint surface and a second object segment, as one of the object segments corresponding to a second three-dimensional data segment, having an upper surface serving as a second joint surface that is one of the joint surfaces corresponding to a second virtual joint surface, or forming the first object segment having a lower surface serving as the first joint surface and the second object segment having a lower surface serving as the second joint surface, the first three-dimensional data segment and the second three-dimensional data segment respectively being one and another one of the three-dimensional data segments divided at the virtual joint surfaces in the data dividing step, the first virtual joint surface of the first three-dimensional data segment being one of the virtual joint surfaces joined to the second three-dimensional data segment, the second virtual joint surface of the second three-dimensional data segment being one of the virtual joint surfaces joined to the first three-dimensional data segment.

5. The method for producing a three-dimensional object according to claim 2, wherein one of the layers of ink including the first joint surface and one of the layers of ink including the second joint surface are each a layer of color ink.
